(19) United States
(12) Patent Application Publication
(10) Pub. No.: US 2015/0046839 A1
(43) Pub. Date: Feb. 12, 2015

(54) INFORMATION PROCESSING APPARATUS, INFORMATION PROCESSING METHOD AND COMPUTER-READABLE MEDIUM

(71) Applicant: Canon Kabushiki Kaisha, Tokyo (JP)

(72) Inventor: Hiroshi Kikuchi, Yokohama-shi (JP)

(21) Appl. No.: 14/328,825

(22) Filed: Jul. 11, 2014

(30) Foreign Application Priority Data
Aug. 9, 2013 (JP) 2013-166994

(51) Int. Cl. H04L 29/08; G06F 3/0481

(52) U.S. Cl. CPC H04L 67/22; G06F 3/0481
USPC 715/752

(57) ABSTRACT

As an application is enabled to dynamically set a list of icons, display character strings and arguments in an OS, share destination applications are displayed as options in one-to-one correspondence with transmission destinations of data, and an argument corresponding to a selected transmission destination is passed to a selected application. In this way, a procedure taken by a user at the time of sharing is simplified.

### BACKGROUND OF THE INVENTION

1. Field of the Invention

The present invention relates to an information processing apparatus, an information processing method, and a non-transitory computer-readable medium that manage a plurality of applications.

2. Description of the Related Art

A method for sharing data among a plurality of applications executed on an operating system has been proposed. Japanese Patent Laid-Open No. 5-280824 describes an example in which a data utility applies type conversion to data if the type conversion is necessary to share the data among a plurality of applications.

Now, consider an interface used to share data among applications (for example, between a first application and a second application). For example, one possible method to cause the second application to share data with the first application is to suggest a user selects an application with which the data is to be shared. At this time, after the user has selected the first application as a share destination, the first application may wish to transmit the shared data to, for example, a server and a printer. In this case, the first application needs to suggest the user selects a transmission destination of the data (a server or a printer to which the data is to be transmitted) again.

There are two problems in suggesting the user makes such selections. The first problem is that the user considers the operation cumbersome. The second problem is that the user is confused because a user interface used to share data among applications differs from a user interface used to select a transmission destination on the first application. In this regard, Japanese Patent Laid-Open No. 5-280824 discloses a method for realizing data sharing among applications, but neither discloses nor assumes a further selection of a transmission destination of data on an application with which the data is shared. This gives rise to the possibility of the occurrence of the aforementioned problems.

### SUMMARY OF THE INVENTION

The present invention improves usability and productivity for a user by realizing a simpler operation procedure.

According to a first aspect, the present invention, there is provided an information processing apparatus, comprising a registration unit that registers a plurality of devices to which a first application transmits data, wherein if an instruction for sharing data of a second application has been accepted, a share screen is displayed on which the plurality of devices registered by the registration unit are selectable as share destinations with which the data of the second application is shared.

The present invention can improve usability and productivity for a user.

Further features of the present invention will become apparent from the following description of exemplary embodiments with reference to the attached drawings).

### BRIEF DESCRIPTION OF THE DRAWINGS

FIG. 1A shows a system configuration.

FIG. 1B shows an internal system configuration of an OS.

FIG. 2 shows an application list.

FIG. 3 shows an example of display by a viewer application.

FIG. 4 shows a share screen according to a first embodiment.

FIG. 5 shows a share screen according to the first embodiment.

FIG. 6 shows a mail transmission screen.

FIG. 7 is a flowchart showing share processing of an inter-application sharing management unit.

FIG. 8 shows a share information list according to the first embodiment.

FIG. 9 is a flowchart showing addition to the share information list.

FIG. 10 is a flowchart showing deletion from the share information list.

FIG. 11 shows a share screen according to a second embodiment.

FIG. 12 shows a share information list according to the second embodiment.

FIGS. 13A and 13B show display screens related to problems.

### DESCRIPTION OF THE EMBODIMENTS

### First Embodiment

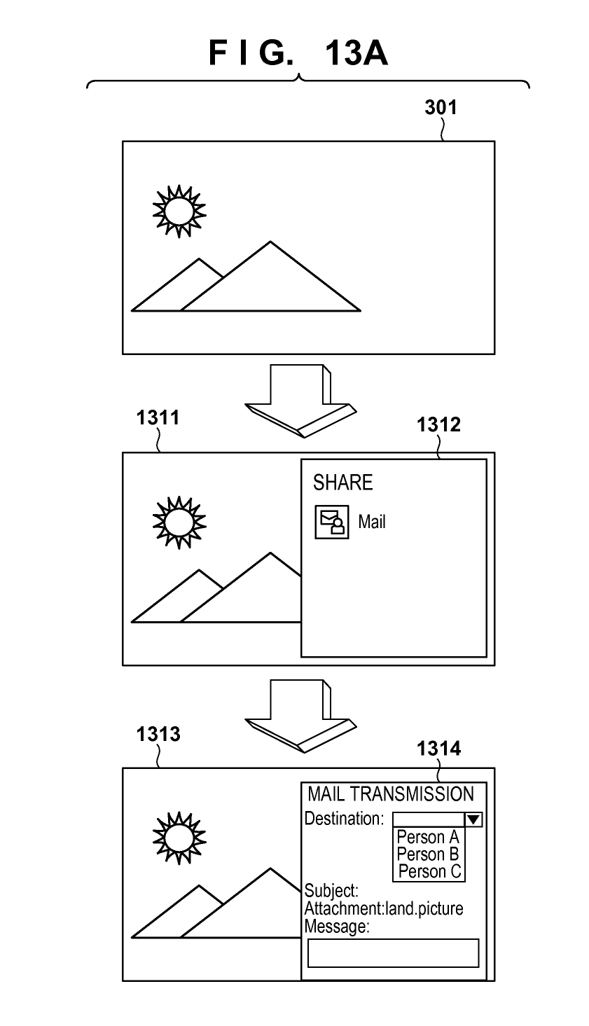

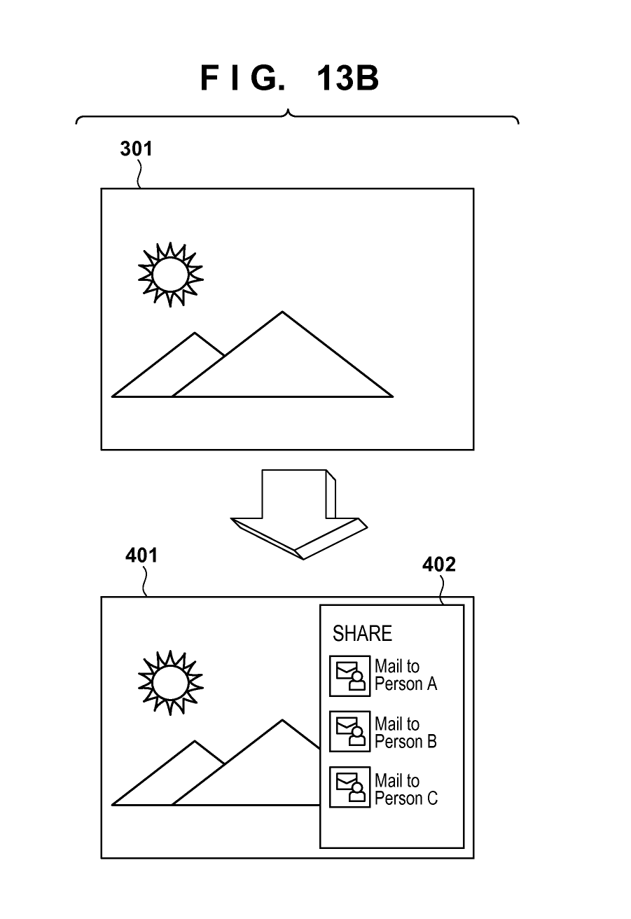

First, an inter-application sharing function will be briefly described. According to the inter-application sharing function, a user selects an application for performing sharing. Then, the user further performs a target operation on a screen of the selected application. Consider an exemplary case where a certain document is transmitted to person A by mail. The user performs an operation for causing a viewer application on which the document is opened to share the document with a mail application (hereinafter referred to as a mailer). Next, the user sets person A as a destination on a screen of the mailer, and transmits a mail. Here, attention should be given to the fact that the above configuration requires an operation to be performed twice, thereby making the operation cumbersome for the user. FIG. 13A is a specific representation of the above configuration. The user causes a share screen 1312 to be displayed via a viewer application screen 301, and further selects a destination on a mailer screen 1314.

In view of this, as shown in FIG. 13B, the present embodiment enables selection of a destination of a mail on a share screen 402 when, for example, data displayed by a viewer application is shared with a mailer application and transmitted by mail. In this way, a simple operation method with excellent usability can be realized. This effect can be similarly achieved with respect to any type of application, including a print application according to a hereinafter-described second embodiment.

The following describes specific configurations that can achieve the effect described with reference to FIG. 13B.

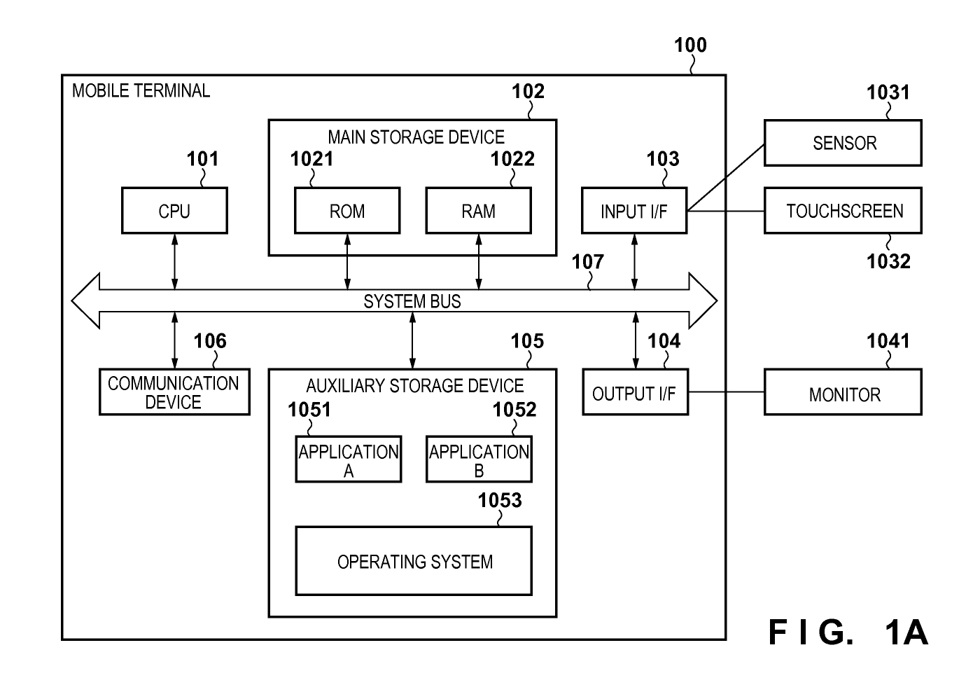

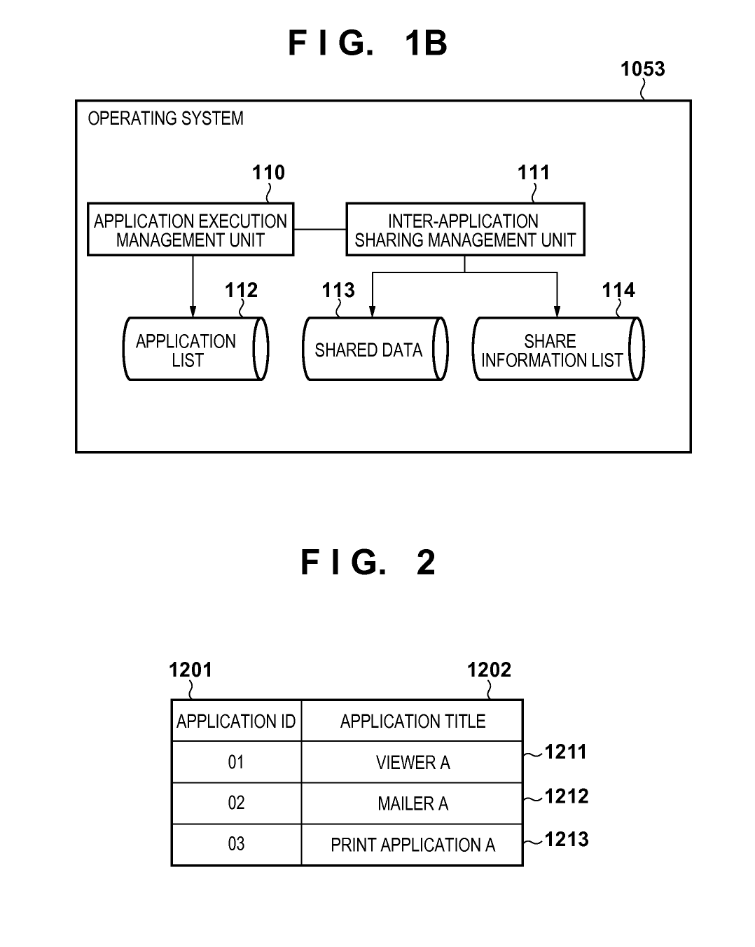

FIGS. 1A and 1B show block configurations of a system of a general mobile terminal 100 representing an embodiment of the present invention. The mobile terminal (hereinafter referred to as a terminal) 100 is an information processing apparatus, that is to say, a computer, and is constructed by a system shown in FIG. 1A. A configuration thereof will be described below in detail.

<Configuration of Mobile Terminal>

A CPU 101 controls the entire apparatus by executing a program stored in a ROM 1021 or a RAM 1022 of a main storage device 102, or in an auxiliary storage device 105. The RAM 1022 is also used as a working area when the CPU 101 executes various types of processing. An operating system (OS) 1053, application software 1051, and the like are recorded in the auxiliary storage device 105.

Input devices, such as various sensors 1031 and a touchscreen 1032, are connected via an input I/F 103. The touchscreen 1032 is a device used by the user to issue various instructions to the terminal 100. An output I/F 104 is an interface for externally outputting data, and outputs data to an output device such as a monitor 1041. A communication device 106 connects the terminal 100 to an external network and line via wireless communication. A reference sign 107 denotes a mutual data system bus for exchanging data among I/Fs and modules. Software of the mobile terminal 100, as well as processes of steps of hereinafter-described flowcharts, is realized by the CPU 101 executing processing based on a program stored in the auxiliary storage device 105.

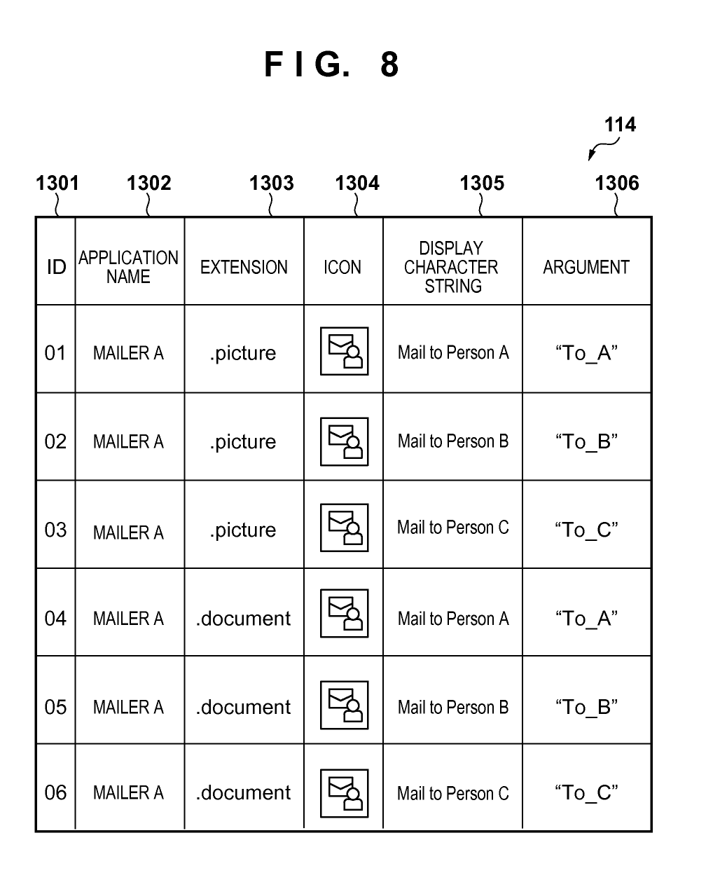

FIG. 1B shows an internal system of the OS 1053 according to an embodiment of the present invention. An application execution management unit 110 has an application list 112 showing installed applications, and manages activation and deactivation of applications. An inter-application sharing management unit 111 manages shared data 113 and a share information list 114. The shared data 113 is a data area shared among applications, and temporarily stores data that the user wishes to share. One example of the share information list 114 is shown in FIG. 8, and specifics thereof will be described later.

FIG. 2 shows the application list 112 of FIG. 1B. Application IDs 1201 are IDs that are uniquely appended to all applications installed in the terminal 100. Application titles 1202 are titles of the applications. FIG. 2 depicts an example in which three applications, that is to say, a viewer A 1211, a mailer (i.e., a mail application) A 1212, and a print application A 1213 are installed in the terminal 100. While the application list 112 also stores attributes of the applications, such as entry points of the applications and memory capacities required by the applications at the time of activation, a description thereof is herein omitted.

<Inter-Application Sharing Function>

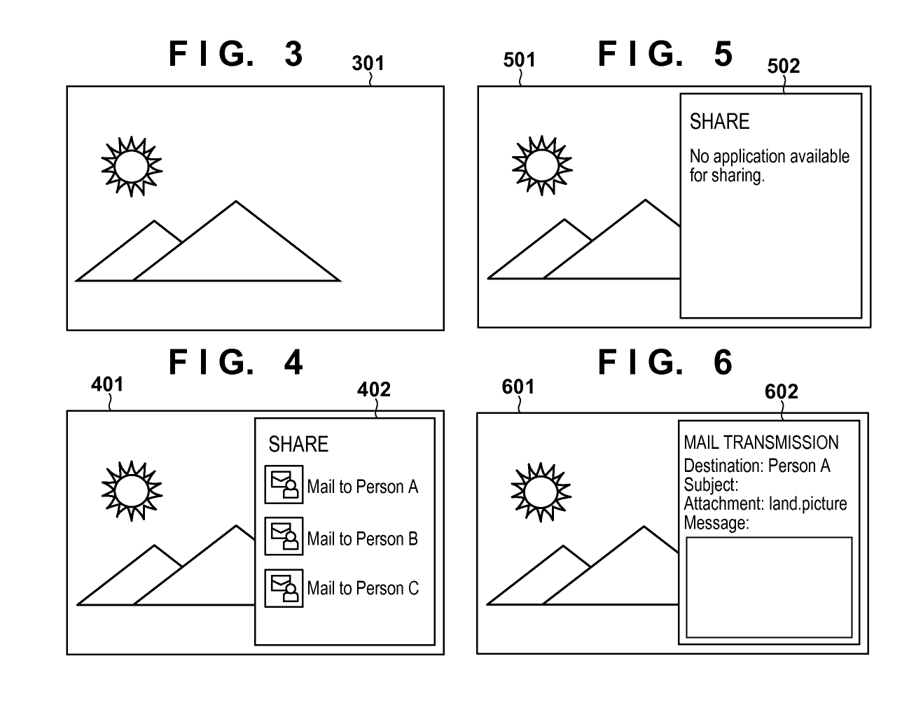

A description is now given of the appearances of an inter-application sharing function according to the present embodiment with reference to FIGS. 3 to 6. FIG. 3 shows one example of an image that is displayed on the monitor 1041 while the viewer A 1211 is being activated. The application execution management unit 110 activates the viewer A 1211 in response to a user instruction. The viewer A 1211 performs rendering in the entire screen region 301 of the monitor 1041 as illustrated. FIG. 3 shows the appearance of a file “land.picture” opened by the viewer A 1211, that is to say, an image with a filename of land.picture.

FIG. 4 shows one example of a screen that is displayed on the monitor 1041 when the user has issued a “share” instruction from the state of FIG. 3. A method for issuing the share instruction will now be described. First, a menu is displayed by performing a specific gesture or pressing a button displayed on a screen. Then, the share instruction can be issued by selecting characters or icons of the displayed menu. A portion shown in a region 401 is rendered by the viewer A 1211, and a portion shown in a region 402 is rendered by the inter-application sharing management unit 111 of the OS 1053. When the share instruction has been issued, the viewer A 1211 recognizes image data that is selected from among image data (in the present example, “land.picture”) displayed at that time as a file to be shared with another application from that time onwards. Then, a filename of the shared file is passed to the inter-application sharing management unit 111. Upon receiving the filename from the viewer A 1211, the inter-application sharing management unit 111 displays a list of applications to which the file can be input in the region 402 as options. At this time, icons and character strings displayed in the region 402 are obtained with reference to the share information list 114. If the share information list 114 does not include any application with which the file can be shared, display is performed to the effect that there is no application with which the file can be shared, as shown on an exemplary screen of FIG. 5. That is to say, the user is notified of the fact that the file cannot be shared with any application. In this case also, a region 501 is rendered by the viewer A 1211, and a region 502 is rendered by the inter-application sharing management unit 111.

To cite a specific product as one example, Windows (registered trademark) 8 provides a sharing function. According to Windows (registered trademark) 8, a popup bar called the charms bar is displayed by applying an inward swipe operation from the right edge of a screen, or by placing a cursor at an upper-right or lower-right corner of a screen, and the charms bar includes an item called “share”. The “share” instruction is realized by clicking or tapping the item “share” in the charms bar. Therefore, in the example of Windows (registered trademark) 8, the screen of FIG. 4 is displayed by clicking or tapping the item “share” in the charms bar while the screen 301 of FIG. 3 is being displayed with the execution of the viewer A 1211. When the share instruction has been issued, a list of applications with which the corresponding data can be shared is displayed in the region 402.

FIG. 6 shows one example of a screen that is displayed on the monitor 1041 when the user has selected an icon displayed together with “Mail to Person A” from among the options in FIG. 4. When the user has selected the icon, the inter-application sharing management unit 111 refers to the share information list 114 and identifies an application associated with the selected icon. In the present example, the icon for “Mail to Person A” is associated with the mailer A 1212 with an application ID 02. Then, the inter-application sharing management unit 111 causes the application execution management unit 110 to activate the mailer A 1212. Referring to FIG. 6, a region 601 is rendered by the viewer A 1211, and a mail transmission screen in a region 602 is rendered by the mailer A 1212. Via the screen in the region 602, the user can transmit a mail attached with the shared image file to person A. It is permissible to adopt the following configuration: person A is set as a default destination via the screen of FIG. 6, and the transmission destination can be changed later on by re-designating a transmission destination in response to a user instruction, as shown on a screen 1313 of FIG. 13A. This re-setting of a transmission destination is similarly applicable to selection of a printer according to a hereinafter-described embodiment.

<Procedure of Share Processing>

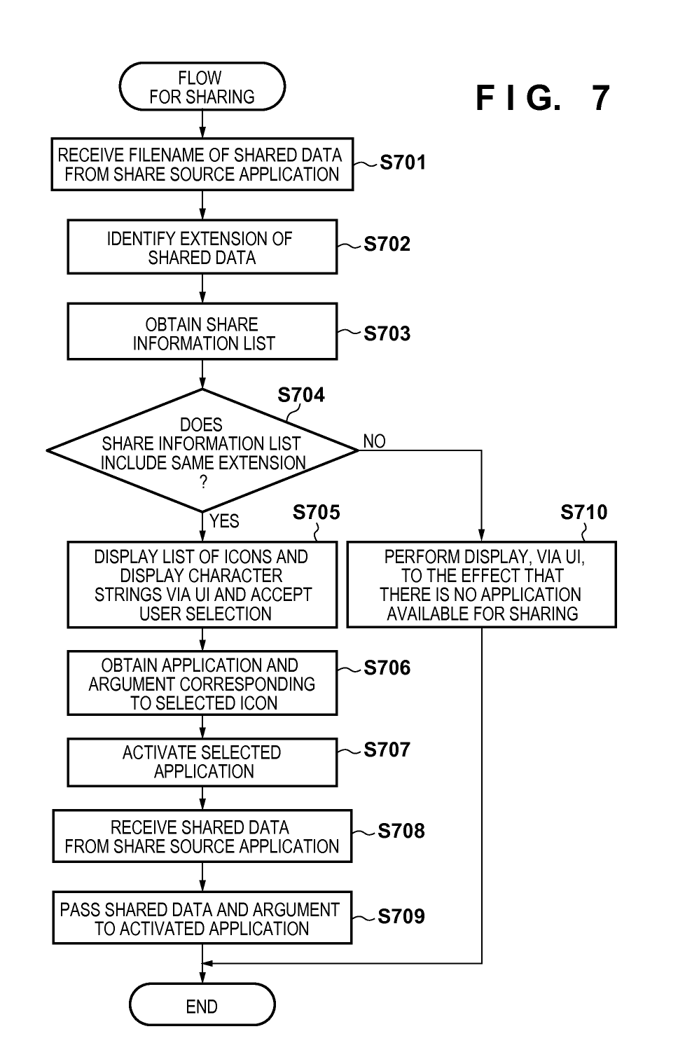

FIG. 8 shows the share information list 114, which will be referred to in the hereinafter description of FIG. 7. Any record in the share information list 114 is defined in the following manner: an application with which data is shared, the type of the shared data, corresponding objects to be displayed, and an argument passed to the application are associated (or in correspondence) with one record. Referring to FIG. 8, IDs 1301 are IDs of the records. Application names 1302 are titles of applications with which data is shared. These application names are titles corresponding to the application titles 1202 defined in the application list 112. Extensions 1303 are extensions of filenames, and indicate the types of data (or the types of applications that can process the data). Icons 1304 are icons used in displaying options from the share information list. Display character strings 1305 are character strings that are displayed together with the icons 1304. Arguments 1306 are arguments that are passed to corresponding applications upon selection of the corresponding applications. Setting at least a part of these arguments in correspondence with the options eliminates the need for the user to set these arguments. A procedure of FIG. 7 is executed with reference to the above-described share information list 114.

FIG. 7 is a flowchart showing the flow of file sharing that has been explained with reference to FIGS. 4 to 6. The following describes a detailed flow of FIG. 7 with reference to the share information list 114 of FIG. 8. The flow of FIG. 7 is executed by the CPU 101. In terms of functional modules of FIG. 1B, the flow is executed by the inter-application sharing management unit 111 and the application execution management unit 110.

Referring to FIG. 7, the inter-application sharing management unit 111 first receives a filename of shared data from a share source application (step S701). More specifically, for example, a character string “land.picture” representing a data filename of data that is currently being displayed is obtained from the viewer A 1211. If the application can open a plurality of pieces of data, a data filename of data that is selected from among opened pieces of data at the time of issuance of a “share” instruction is obtained. Then, the inter-application sharing management unit 111 identifies an extension from the received filename (step S702). More specifically, for example, “.picture” is the extension. In the present embodiment, an application with which data can be shared is identified based on an extension; however, in practice, the present embodiment can be implemented by identifying an application with which data can be shared based on other elements, such as an attribute of a file. In the present embodiment, it will be assumed that an extension of a file is exclusively used. In step S703, the inter-application sharing management unit 111 obtains the share information list 114 managed by itself. Then, the inter-application sharing management unit 111 determines whether or not the share information list 114 includes the same (matching) extension (step S704). More specifically, it determines whether or not the share information list 114 includes at least one record in which “.picture” is registered as the extension 1303. If there is no such record, processing proceeds to step S710, and display is performed to the user to the effect that there is no application with which data can be shared. The region 502 of FIG. 5 represents a UI screen for this occurrence. On the other hand, if there is at least one such record, a list of all icons and display character strings included in the corresponding records is displayed via a UI, and a user selection is accepted in step S705. The icons and display character strings that are displayed here correspond to the icons 1304 and the display character strings 1305 in the share information list 114, respectively. In the example of FIG. 8, three records with the IDs 1301 of 01 to 03 include “.picture” as the extension, and three icons and character strings showing “Mail to Person A”, “Mail to Person B”, and “Mail to person C” are displayed via the UI. The region 402 of FIG. 4 represents a screen for this occurrence. If the user selects one of these icons, the inter-application sharing management unit 111 proceeds to step S706. In step S706, an application name and an argument corresponding to the selected icon are obtained using the share information list 114. It will be assumed that the user has selected the icon for “Mail to Person A”. That is to say, the inter-application sharing management unit 111 obtains an application title “Mailer A” and an argument “To_A” corresponding to the selected icon from the application names 1302 and the arguments 1306, respectively. Then, the inter-application sharing management unit 111 causes the application execution management unit 110 to activate the mailer A 1212 (step S707). Thereafter, in step S708, the actual shared data is received from the share source application and temporarily stored in the shared data 113. That is to say, the “land.picture” file is received from the viewer A 1211. Finally, in step S709, the shared data “land.picture” and the argument “To_A” are passed to the share destination application, that is to say, the mailer A 1212. Through the above-described flow, inter-application sharing of the present embodiment is carried out.

While the same application, that is to say, the mailer A 1212 is used as a share destination application with which the data share source application “viewer A” can share data in the present example, the feature of the present embodiment is that three different icons, as well as three different display character strings, are displayed on the share screen 402 as a list in one-to-one correspondence with three different arguments. In this way, the user can identify a destination simply by making a single selection via the share screen 402. That is to say, the effect of reduction in an operation procedure at the time of inter-application sharing can be achieved. The application (in the present example, the mailer A 1212) that has received the shared data and the argument (in the present example, “land.picture” and “To_A”, respectively) identifies “Person A” as a destination, as shown on the mail transmission screen 602, judging from the argument “To_A”. For example, the destination is identified by searching an address book for “A”. Furthermore, the shared file received from the inter-application sharing management unit 111 is set as an attachment file of a mail to be transmitted. Thereafter, the mail is transmitted.

<Maintenance of Share Information List>

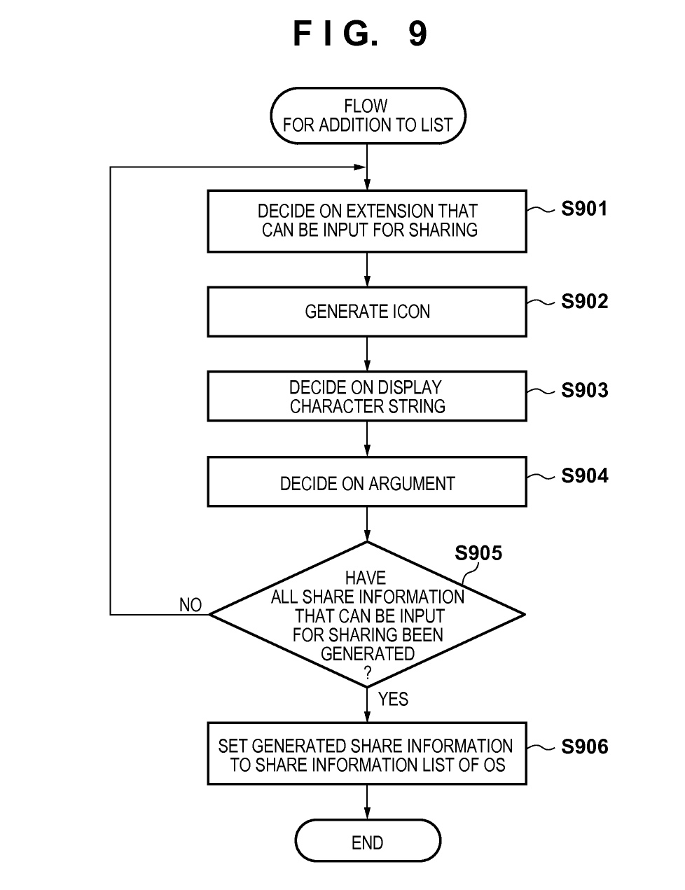

An application installed in the terminal 100 can dynamically make addition to and deletion from the share information list 114. With reference to a flowchart of FIG. 9, the following describes a procedure in which the mailer A 1212 installed in the terminal 100 adds share information of the share information list 114. Specifically, the following describes an example of a procedure for adding share information with IDs 01 to 03 of the share information list 114 shown in FIG. 3. The mailer A 1212 is mail software, and it will be assumed that person A, person B, and person C are pre-registered as transmission destinations of a mail. The user can attach a file to a mail by causing a share source application to share the file with the mailer A 1212, and transmit the mail to a desired destination.

First, in step S901, the mailer A 1212 decides on an extension of a file that it can input. It should be noted that it may, for example, cause the user to input an extension instead of making this decision. It will be assumed that an extension “.picture”, which denotes a picture file, can be input. Next, in step S902, the mailer A 1212 generates an icon to be displayed on the share screen 402. The mailer A 1212 further decides on a display character string to be displayed simultaneously with the icon that was generated in the previous step S903. It will be assumed that it decides on “Mail to Person A”. It should be noted that it may, for example, cause an icon and a character string generated by the user to be input instead of adopting the method for generating an icon in step S902 and the method for deciding on a character string in step S903. The mailer A 1212 further decides on an argument to be received from the inter-application sharing management unit 111 together with shared data upon selection of the icon. It will be assumed that it decides on “To_A”. It should be noted that it may, for example, cause the user to input an argument instead of making this decision. The above-described set of the extension, icon, display character string, and argument is referred to as one piece of share information. The mailer A 1212 repeats steps S901 to S904 for “Mail to Person B” and “Mail to Person C” as well, and proceeds to the next step S906 after generating all share information that can be input (step S905). In step S906, the mailer A 1212 sets the share information generated in the above-described manner to the share information list 114 of the OS 1053. It should be noted that the title of the application that executes the procedure of FIG. 9 is registered as the application name 1302. Furthermore, the ID 1301 of each record is obtained by, for example, adding 1 to the ID of the immediately previous record in the share information list 114. In this way, the mailer A 1212 can dynamically add share information to the share information list 114. For example, if person D is added as a transmission destination of a mail, “Mail to Person D” can be added to the share information list by similarly executing steps S901 to S906.

It should be noted that, as the share information list 114 is information managed by the OS 1053, in step S906 in which a file is operated but the application is not directly operated, a request for addition may be issued to the inter-application sharing management unit 111 together with the generated share information, and the inter-application sharing management unit 111 may add a record in response to the request. In this case, an ID is appended by the inter-application sharing management unit 111.

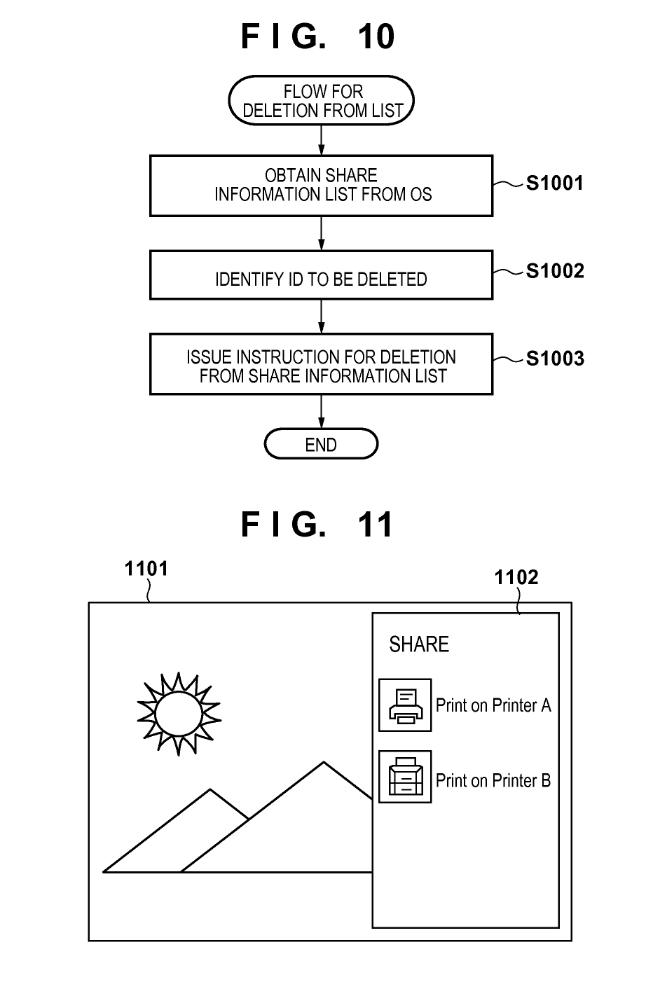

On the other hand, FIG. 10 shows a procedure in which the viewer A 1211 installed in the terminal 100 deletes share information of the share information list 114. Specifically, the following describes an example in which person A, who was set as a transmission destination of a mail, has been deleted from the transmission destination. As person A has been deleted from the transmission destination, the mailer A 1212 needs to delete “Mail to Person A” from the share information list 114. First, in step S1001, the mailer A 1212 obtains the share information list 114 from the OS 1053. Next, in step S1002, it identifies an ID of share information to be deleted. Referring to FIG. 8, IDs 01 and 04 are IDs of share information to be deleted. Then, the mailer A 1212 requests the inter-application sharing management unit 111 of the OS 1053 to delete share information with the identified IDs from the share information list 114.

As shown in FIGS. 9 and 10, the inter-application sharing management unit 111 accepts, from an installed application, requests for making addition to and deletion from the share information list 114, and updates the share information list 114 in response to the requests.

The above-described operations of the inter-application sharing management unit 111 enable the user to carry out inter-application sharing, that is to say, cause any application to share data with any other application. In particular, when the share screen 402 is displayed, a plurality of icons are already provided as options although there is one share destination application; therefore, target share processing can be executed in a short operation procedure. Furthermore, as an application dynamically adds and deletes operations at the time of sharing, the user can perform a share operation on a situation-by-situation basis.

### Second Embodiment

In the first embodiment, the mailer A 1212 has been described as an example of a share destination application. In the second embodiment, a print application A 1213 is used as an example of a share destination application, and differences are described. The print application A 1213 is an application that can issue a print instruction to a printer. The print application A 1213 has a function of converting an image and a document in the terminal 100 into a PDL (page description language), which is a data format that can be interpreted by a printer. Printing is enabled by transmitting the converted PDL to a printer over a network. The communication device 106 is used for connection between the terminal 100 and a printer in a network. While software called a printer driver can be generally used to execute printing, the feature of the present embodiment is that the use of the print application A 1213 enables printing without installation of a printer driver in the terminal 100. The print application outputs the generated PDL directly to a printer that executes printing. A plurality of printers can be registered as executors of printing, and the registration can be performed in the form of manual registration by designation of ports, and automatic registration by network search. The print application A 1213 can also retrieve data to be printed through an inter-application sharing function of another application.

FIG. 11 depicts the case where a data file “land.pdf” opened by the viewer A is shared with the print application A 1213 through inter-application sharing. This corresponds to FIG. 4 of the first embodiment. A region 1101 is rendered by the viewer A 1211, and a region 1102 is rendered by the inter-application sharing management unit 111. The user can print “land.pdf” on a printer A registered in the print application A 1213 by selecting an icon for “Print on Printer A”.

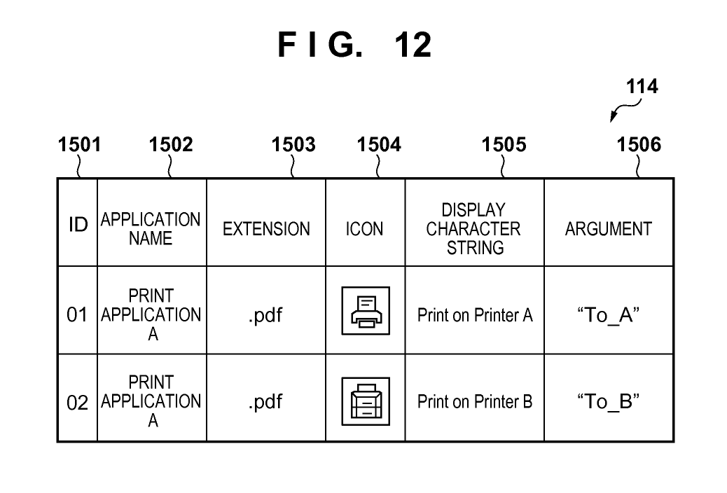

FIG. 12 shows a share information list 114 that realizes FIG. 11. Two pieces of share information of the print application A 1213, which serves as a share destination of an extension “.pdf”, are registered. One is “Print on Printer A”, and the other is “Print on Printer B”. If the user selects the icon for “Print on Printer A” in the region 1102, shared data “land.pdf” and an argument “To_A” corresponding to the selected item are passed to the print application A 1213 (step S709). The print application A 1213 identifies the printer A as an executor of printing based on the argument “To_A”, converts the “land.pdf” file into a PDL appropriate for the printer A, and executes printing. With the implementation of the present embodiment, the user can issue a desired instruction only by making a single selection without going through two procedures, that is to say, sharing with the print application A 1213 and then selecting a printer as an executor of printing.

It is evident that the share information list 114 of FIG. 12 has been additionally registered by the print application A 1213 as “Print Application A” is registered as an application name 1502. As stated earlier, the print application A 1213 can register a plurality of printers as executors of printing. Each time the number of registered printers is increased or decreased, the print application A 1213 updates the share information list 114 by executing the flows of FIGS. 9 and 10. In this way, registered printers can always be displayed as options for executors of printing in the region 1102 at the time of inter-application sharing.

However, the above-described implementation has the following problem: if the number of printers registered in the print application A 1213 significantly increases, a large number of options are listed in the region 1102 at the time of inter-application sharing. To address this problem, the print application A 1213 can set an upper limit on the number of pieces of share information registered in the share information list 114. For example, if the upper limit is five, the print application A 1213 registers only five pieces of share information at most in the share information list 114, even if the number of registered printers has been increased or decreased. The foregoing processing is also executed by the print application A 1213 executing the flows of FIGS. 9 and 10. A printer that has recently executed printing, a printer that executed printing many times in the past, and the like can be used as criteria for selection of a printer to be registered in the share information list 114. This eliminates the need for the user to make a selection from among a large number of options at the time of inter-application sharing.

Icons 1504 of FIG. 12 are generated by the print application A 1213 in step S902. It is preferable that the print application A 1213 generates an icon for “Print on Printer A” such that the icon makes the printer A distinguishable to the greatest extent possible. To this end, the print application A 1213 can obtain the icon of the printer A from an external server over a network. The icon can also be generated based on a correspondence list that shows the correspondence between printer names and icons and is internally held by the application A in advance. Alternatively, the icon may be generated by requesting the user to select the icon from among a plurality of icons prepared in advance via a setting UI of the application A. This makes it easy for the user to accurately select a printer as an executor of printing.

### Third Embodiment

The first and second embodiments have described an example in which the inter-application sharing management unit 111 lists all icons and display character strings registered in the share information list 114 in step S705. However, this process has the following problem: if a large amount of share information has been inadvertently registered by an application, it becomes difficult for the user to search for a desired icon. To address this problem, the inter-application sharing management unit 111 may set an upper limit on a predetermined number of icons that are displayed as a list for one share destination application in step S705. In this way, an inadvertent increase in the number of icons can be prevented.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-166994, filed Aug. 9, 2013, which is hereby incorporated by reference herein in its entirety.

What is claimed is:

1. An information processing apparatus, comprising
a registration unit that registers a plurality of devices to which a first application transmits data, wherein
if an instruction for sharing data of a second application has been accepted, a share screen is displayed on which the plurality of devices registered by the registration unit are selectable as share destinations with which the data of the second application is shared.

2. The information processing apparatus according to claim 1, wherein
if one of the plurality of devices on the share screen has been selected as a share destination of the data of the second application, the first application transmits the data to the selected device.

3. The information processing apparatus according to claim 1, wherein
if an extension of the data shared by the second application matches an extension processable by the first application, the share screen is displayed on which the plurality of devices are selectable as the share destinations of the data of the second application.

4. The information processing apparatus according to claim 1, wherein
if a device has been selected as a share destination of the data of the second application on the share screen, the first application displays the selected device as a default transmission destination of data of the first application, and further changes the device serving as the transmission destination if an instruction for changing the transmission destination has been accepted from a user.

5. The information processing apparatus according to claim 1, wherein
the registration unit registers the plurality of devices in a list, and
the information processing apparatus further comprises
a deletion unit that deletes a device from the list.

6. The information processing apparatus according to claim 1, wherein
the registration unit registers up to a predetermined number of devices as the plurality of devices.

7. The information processing apparatus according to claim 1, wherein
for each application, the share screen displays up to a predetermined number of share destinations as the share destinations.

8. The information processing apparatus according to claim 1, wherein
the devices are printers.

9. An information processing method comprising
registering a plurality of devices to which a first application transmits data, wherein
if an instruction for sharing data of a second application has been accepted, a share screen is displayed on which the plurality of registered devices are selectable as share destinations with which the data of the second application is shared.

10. The information processing method according to claim 9, wherein
if one of the plurality of devices on the share screen has been selected as a share destination of the data of the second application, the first application transmits the data to the selected device.

11. The information processing method according to claim 9, wherein
if an extension of the data shared by the second application matches an extension processable by the first application, the share screen is displayed on which the plurality of devices are selectable as the share destinations of the data of the second application.

12. The information processing method according to claim 9, wherein
if a device has been selected as a share destination of the data of the second application on the share screen, the first application displays the selected device as a default transmission destination of data of the first application, and further changes the device serving as the transmission destination if an instruction for changing the transmission destination has been accepted from a user.

13. The information processing method according to claim 9, wherein
the plurality of devices are registered in a list, and
the information processing method further comprises
deleting a device from the list.

14. The information processing method according to claim 9, wherein
up to a predetermined number of devices are registered as the plurality of devices.

15. The information processing method according to claim 9, wherein
for each application, the share screen displays up to a predetermined number of share destinations as the share destinations.

16. The information processing method according to claim 9, wherein
the devices are printers.

17. A non-transitory computer-readable medium having recorded therein a program for causing a computer to execute an information processing method that comprises
registering a plurality of devices to which a first application transmits data, wherein
if an instruction for sharing data of a second application has been accepted, a share screen is displayed on which the plurality of registered devices are selectable as share destinations with which the data of the second application is shared.
